(19) United States
(12) Patent Application Publication
(10) Pub. No.: US 2014/0115561 A1
(43) Pub. Date: Apr. 24, 2014

(54) Apparatus and Method for Creating a Program For Computer-controlled Machines

(71) Applicants: Axel Hessenkämper, Gutersloh (DE); Klaus-Dieter Becker, Leichlingen (DE)

(72) Inventors: Axel Hessenkämper, Gutersloh (DE); Klaus-Dieter Becker, Leichlingen (DE)

(21) Appl. No.: 13/992,197

(22) PCT Filed: Dec. 7, 2011
(86) PCT No.: PCT/EP2011/072099

§ 371 Date: Dec. 20, 2013

(30) Foreign Application Priority Data
Dec. 7, 2010 (DE) 10 2010 053 668.7

(51) Int. Cl. G06F 9/44

(52) U.S. Cl. CPC G06F 8/31
USPC 717/114

(57) ABSTRACT

A method for creating a program for controlling the operation of a computer-controlled machine includes providing a conversion program for converting a first program in a programming language into an executable second program in a machine language, writing a first program in the first programming language, and converting the first program using the conversion program into an executable second program in the machine language.

The invention relates to a method and an apparatus for creating a program for controlling the operation of a computer-controlled machine according to the preambles of the independent claims.

Computer-controlled machines are complex automats, the operation of which is software-controlled. Examples are manufacturing robots, an assembly line or a machine tool. The latter are, for example, machines in which, on the one hand, the particular processing of a workpiece by a tool is to be controlled, but in which, on the other hand, also further functions are to be controlled which serve for or are necessary for operating the machine. Exemplarily, safety functions, monitoring operating supplies (compressed air, oil, . . . ) chip discharge and the like may briefly be mentioned here.

The control of complex machines is performed by digital computers in connection with suitable interfaces to connect to the machine. For the controlling computers there are a number of manufacturers such as Heidenhain, Siemens, Fanuc, Rexroth . . . . The controls produced by the various manufacturers represent proprietary platforms, respectively (PLC Design, Siemens Simatic, Fanuc Ladder, . . . ), which are not interchangeable and, in particular, are not standardized with regard to their programming and their process interfaces.

Apart from that, machine manufacturers often offer control systems of several different producers for the same machine, so that a control software for the same machine cannot be uniformly generated, but in dependence on the platform must be written each time anew for finally the same functionalities.

A further disadvantage in the creation of programs for machines is that hitherto no easy-to-handle programming language has existed that would make it possible for less specialized users to write a control software. Rather, the individual platforms require a detailed knowledge about the particularities of each platform, in order to be able to write accordingly adapted programs in a very machine-oriented form.

The European Standard EN 61131 is based on the international Standard IEC 61131 and describes basics of programmable logic controllers. A part of this Standard describes programming languages of programmable logic controllers. There are defined an instruction list comparable to an assembler for the PC programming, a contact diagram similar to a circuit diagram, a function block diagram resembling logical diagrams, a sequential function chart similar to state charts, and structured text which is based on high-level languages. The instruction list and the structured text are character-based, whereas the others are of graphic design. The disadvantage of the here described concepts is that they do not specify a uniform programming and require a very machine-oriented programming.

It is the object of the invention to provide a method and an apparatus which make possible the simple creation of programs for computer-controlled machines.

This object is solved with the features of the independent claims. Dependent claims are directed on features of preferred embodiments of the invention.

A method for creating a program for the control of the operation of a computer-controlled machine comprises the steps of: providing a conversion program for converting a first program in a programming language into an executable second program in a machine language, writing a first program in the first programming language, and converting the first program using the conversion program into an executable second program in the machine language. The first programming language need not be machine-oriented, but can be (more) easily comprehensible for man, so that the machine programming is facilitated and supported.

The step of writing the first program can comprise the following steps: prior provision of a collection of program parts, and later the compilation of program parts from the collection to a first program. Program parts which are often programmed in the same way can thus be prepared and, afterwards, can be used very quickly. The first program can be written by using a graphical user interface.

The conversion program can be designed so that it can generate, starting from the first program, the second program in several machine languages. In the concrete conversion process, then, the target machine language is selected. The first program is then converted into this target language. However, the conversion can also routinely be made always into all possible machine languages.

The program generated by the conversion device can be a program which, in operation, is cyclically repeatedly executed.

An apparatus for generating an executable second program in a machine language for controlling the operation of a computer-controlled machine tool starting from a first program comprises an input device for inputting the first program, and a conversion device for converting the first program into the second program. It can comprise a selection device for selecting one of a plurality of possible machine languages in which the second program is to be generated.

A further aspect of the invention is a data carrier comprising data which, when they are used in a computer for the program execution, yield an apparatus as indicated above.

In the following, individual embodiments of the invention are described with reference to the drawings.

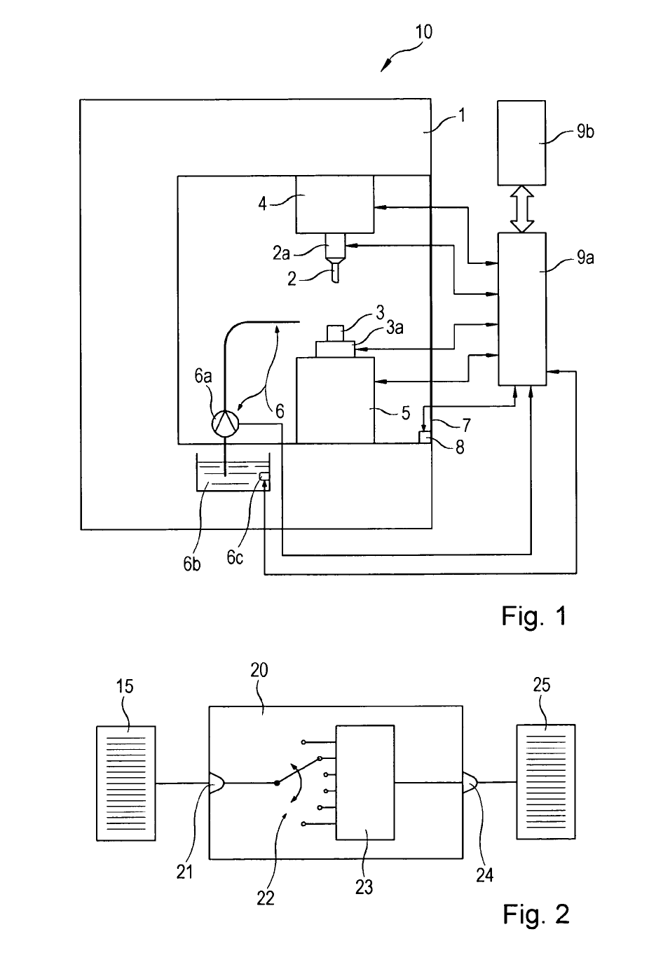

FIG. 1 schematically shows a machine for which a program can be generated according to the invention,

FIG. 2 schematically shows a conversion device,

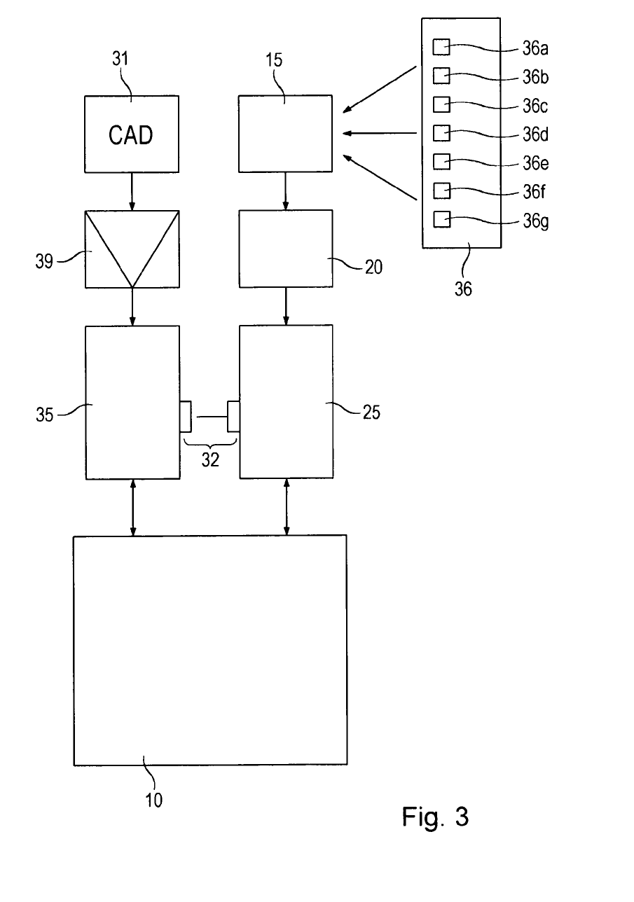

FIG. 3 shows a program structure as it can be present in a more complex machine, with at least parts thereof being creatable according to the invention, and

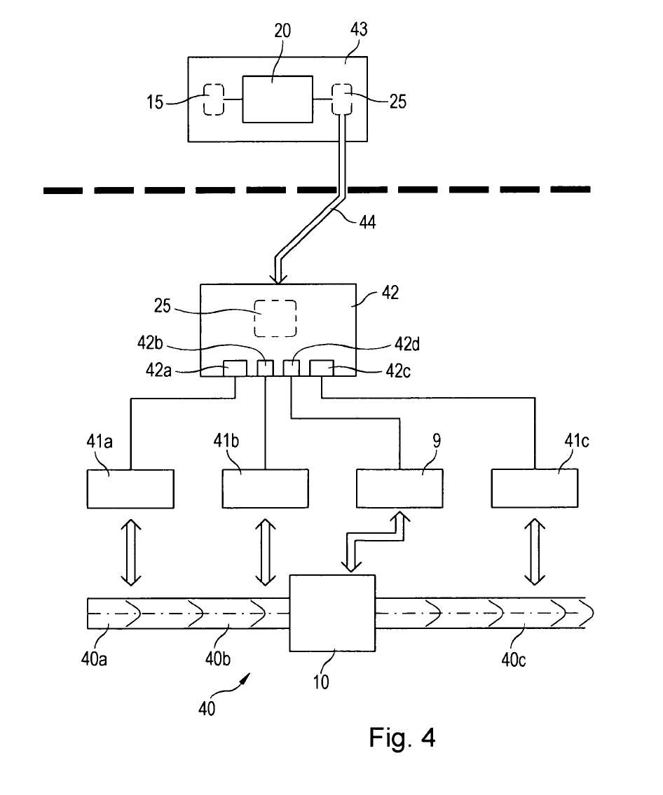

FIG. 4 schematically shows the hardware structure in which the invention is applied.

FIG. 1 shows as an example of a complex machine a machine tool 10 comprising a machine frame 1, a tool 2 in a tool holder 2a, a workpiece 3 on a workpiece table 3a, static and dynamic actuators 4 for the tool, static and dynamic actuators 5 for the workpiece, as an example of one of a plurality of auxiliary functions a coolant supply 6 with a pump 6a, a coolant reservoir 6b and a filling level sensor 6c, a door 7, a door sensor 8, and a control system 9a and a storage 9b.

In a machine tool the primary function is the manufacture of the workpiece. The program for this purpose is often generated partly automatedly starting from CAD data via specific intermediate steps. However, there remain many functionalities to be additionally controlled such as the above-mentioned cooling system 6 or the monitoring of the door 7. Numerous other such functions (tool management, user interface, chip control, workpiece and tool monitoring, querying of sensors, . . . ) are present. In addition to the actual manufacturing program a further program is to be generated for these functions, which meets the above-mentioned tasks.

In the machine tool 10 the manufacturing program as well as the additional program will finally be executed in the control system 9 and will act upon the machine via suitable interfaces from and to the machine. Since, as it was said at the beginning, the producers of the control systems 9 do not have a uniform standard for the programming, the concrete programming is to be performed in dependence on the respective producer of the control system 9. If machine manufacturers want to provide their clients with already pre-programmed program parts, they must finally program them for each control producer separately, so that, in dependence on which control producer the client wishes for the machine 10, the suitable software parts (e.g. coolant control and monitoring, door monitoring) can be supplied at the same time. Moreover, the respective program must be written in a machine-oriented language, since high-level languages for the programming of control systems for complex machines have not been developed.

FIG. 2 shows an apparatus 20 by means of which the above-mentioned difficulties can completely or partly circumvented. The apparatus 20 is a conversion device by means of which a first program 15 can be converted into a second program 25. The first program 15 can be written in a high-level language which replaces the machine-oriented programming. The high-level language can be designed so as to be suitable for enabling a user based on his knowledge to write a program after a short initial training. The user may be a skilled worker who is to surveil the production process in the machine hall of a plant. He should be able to write the program 15 without having to acquire extensive computer skills.

The first program 15 may be created completely or partly in a graphical user interface. The graphical user interface can render many requirements intuitively graspable and manageable. Then, via the graphical user interface inputs can be made which lead, step by step, to the creation of the first program 15.

The first program 15 is input by an input device 21 into the conversion device 20 and, there, in a conversion device 23 is converted into the second program 25 which is output through an output device 24, e.g. as a stored file or a collection of files which can, then, concretely be used for the machine control. The second program 25 is written in adaptation to the respective type of control system 9, i.e. it is eventually manufacturer-specific again.

In a simple embodiment, a conversion device 20 can convert the input first program 15 only into a second program 25 of a predetermined language (i.e. finally adapted to a particular manufacturer of the desired control system 9). In comparison thereto, FIG. 2 shows an already further developed embodiment. A selection device 22 is provided by which one can select in which language the second program 25 is to be generated, i.e. for which control producer it is to fit. As the case may be, one or more languages can be selected as the language of the second program 25 and, accordingly, the conversion device 20 generates second programs 25 which are equal in their effects and only differ in the machine language which is used. The selection options in the selection device 22 finally correspond to the control producers (as initially mentioned: Heidenhain, Siemens, Fanuc, Rexroth, . . . ) who are supported by the conversion device 20.

Instead of a selection it can also be provided to always generate the second program as standard in all machine languages which are supported by the apparatus 20. Insofar, a mode switching between a first mode (one or more machine languages can be selected) and a second mode (a plurality of second programs in all supported machine languages) can be provided.

An often necessary step when generating the second program 15 is the allocation of storage locations of data and/or the selection of options of access to storage locations. Since, differently from conventional PCs, machine control systems often do not have a convenient operating system including file management, input/output system, and the like, which adopt many functions automatically without a user even noticing this, for the machine programming—differently from the PC programming—many basic functionalities must be programmed as well. This also has an impact on the design of the conversion device 20 and, possibly, the creation of the first program 15.

In machine tools, in particular storage locations for data (such as parameters, status variables, intermediate data, flags, . . . ) must explicitly be allocated. Moreover, the data access mode must often be determined (e.g. whether writing/reading has to be performed bitwise or bytewise). These are determinations which can either be made in the first program 15 and which are then converted by the conversion device 20 through appropriate devices into corresponding executable instructions in the second program 25, or which are ascertained in the conversion device 20 by appropriate means based on implicit indications in the first program (e.g. definition of variables) or based on provided prior information (e.g. as to storage locations and storage options) and are worked into the second program. As far as the mentioned determinations in the first program are expressly made, these mentioned determinations (storage location allocation, access control) can be made based on a graphical user interface.

A further relevant aspect of the considered programs is the data acquisition from the controlled process or the controlled machine. They can comprise one or more or a plurality of sensors, the data of which must be recorded and processed. Accordingly, the first program 15 can comprise sensor commands for the sensor querying, data recording, data formatting, time control, influencing of the analog/digtal conversion (e.g. influencing of the zero point and gain during the conversion) and data storage, in each case relating to data which are provided by process sensors/machine sensors. These sensor commands can be adapted to the respective sensor interfaces from the machine 10 to the control system 9. In accordance therewith, the conversion device 20 can be adapted to receive such sensor commands, also in their adaptation to the respective sensor interface, in the first program 15 and to convert the same in corresponding executable instructions in the second program 25 in the respective machine language.

A further relevant aspect of the considered programs is the data output to the controlled process or the controlled machine. The machines have numerous actuators or controlling elements (e.g. coolant pump, chip conveyance, but also axis control, tool drive), the control of which by the second program 25 can be desirable. Accordingly, the first program 15 can comprise actuator commands for the generation, the formatting, the time-control, the influencing of the digital/analog conversion (e.g. influencing the zero point and gain during the conversion) and the output of commands for actuators of the process or of the machine. These commands of the actuators can be adapted to the respective actuator interfaces from the control system 9 to the machine 10. Accordingly, the conversion device 20 can be designed to receive such commands of actuators, also in their adaptation to the respective actuator interface, in the first program 15 and to convert them into corresponding executable instructions in the second program 25 in the respective machine language.

The properties of the interfaces to and from the actual process (machine, sequence), which interfaces are mentioned in the above description of the actuator commands and sensor commands, can also be taken into consideration in that interface data describing relevant properties of the interfaces are indicated separately (e.g. characteristic of the control voltage over the target output) and the conversion from the first into the second program is effected with reference to the first program as well as with reference to the interface data. The first program can, e.g., make qualitative indications (e.g., pump output P=50% of Pmax) which are then converted also based on the interface data into actual control commands in the second program (e.g. a particular control voltage or pulse width for the pump).

The above-mentioned actuator commands and sensor commands can explicitly be entered into the first program 15 and are then converted by the conversion device 20. When programming the first program 15 via a graphical user interface they can also be input directly by setting them via the graphical user interface. In this case, too, they are converted by the conversion device 20.

FIG. 3 shows, in a structurally subdivided way, the programming of a machine tool 10. What is shown is a structure in which two programs 35 and 25 control the machine. The program 35 is the actual tool and workpiece control and serves for the concrete manufacture of the workpiece through the tool. It is generated starting from the CAD data 31 by a structure 39 not explained in detail. The second program 25 serves for controlling auxiliary functions such as the monitoring of the door sensor 8 or the coolant sensor 6c, as they are shown in FIG. 1, in order to mention some simple examples. Numerous other functions are also to be controlled.

The second program 25 is generated, as described above, starting from a created program 15 by the conversion device 20 in the language which is suitable for the used control system 9 on which the program is to run. Between the second program 25 and the third program 35 interfaces 32 are desirable, since the results obtained from the different controlled processes mutually influence each other. E.g., the workpiece processing (using program 35) must be interrupted when (using program 25) it is ascertained that the coolant circuit is defect (sensor 6c in FIG. 1) or that the cabin door (sensor 8) has been opened.

In order to make possible the interaction between the second program 25 and the third program 35, interfaces 32 can be provided which can/must already be formed in the first program 15, what is indicated by arrows 14 in FIG. 3. The conversion device 20 is then accordingly designed for converting the formed interface 14 in the first program 15 into an actual interface functionality 32 of the second program 25, so that the running second program 25 can communicate with a running third program 35.

An interface between the second and the third program can comprise: format specifications as to data inputs and/or outputs, and/or timing specifications as to data inputs and/or outputs, and/or storage specifications for the storing and reading of data (e.g. storage location for data to be transmitted) and/or communication control specifications.

The second program can control one or more of the following machine functions: control and monitoring of operating materials, control and monitoring of the machine status, user interface, tool management and tool exchange, chip control, workpiece monitoring, tool monitoring, safety devices, axis drive, operation of sensors, here particularly querying of sensors and data acquisition. The third program can control one or more of the following machine functions: tool drive, axis drive, operation of sensors, collision monitoring.

The creation of the first program 15 can completely or partly be effected by means of a beforehand provided collection 36 of program parts 36a-36g, from which, when the first program is concretely generated, one or more program parts are selected and compiled. Apart from the mere selection of program parts it can also be provided to set control parameters for the respective program parts (e.g.: delivery rate of the coolant) in the course of the generation of the first program. These steps (selection of program parts, setting of parameters), too, can be performed in a graphical user interface.

The second program 25 is preferably generated clearly before the point of time at which it is used.

The same holds true for the third program 35. However, also the real-time generation of the second program 25 is possible.

The generated programs serve, e.g., for controlling complex machine tools (e.g. turning machines, milling machines, ultrasonic machines, laser ablation machines) or processing machines (such as one or more robots). Also chemical reactors can be the control target of the programs to be generated.

FIG. 4 shows a further structure in which the invention can be applied. 40 symbolizes a complex technical plant with many components 10, 40a-c therein, which in addition to other components can comprise, e.g., the machine 10 of FIG. 1. One or more numerical control systems 9, 41a-c serve for controlling or feedback-controlling the individual plant components 10, 40a-c. The one or more numerical control systems 9, 41a-c are connected with a superordinated programmable logic control 42 via respectively suitable interfaces 42a-c (which can correspond to the interface 32).

Thus, there ensues a hierarchic structure of one or more numerical control systems 9, 41 directly at or near to the process/plant 40, on which the mentioned third programs 35 run, and at least one superordinated programmable control system 42 on which the second program 25 runs, and for the generation of which the method is designed.

43 symbolizes hardware, e.g. a computer which can be process-remote, on which the components 20-24 of FIG. 2 are implemented. In the computer 43 the second program 25 is generated. It is then installed on the programmable control system 42 via a suitable connection 44 (e.g. network connection or conventional data carrier transport), where it can be executed.

In the embodiment of FIG. 4, in the computer 43 the claimed method generates as the second program 25 preferably a program for the hierarchic superordinated programmable control system 42 which is designed for communicating with hierarchically subordinated numerical control systems 41a-c, the respectively running programs of which (third programs 35) can be generated otherwise.

The second program 25 has, on the one hand, one or more central program parts for performing the primary objects of the programmable control system 42 (process or plant control), but on the other hand also has interface program parts which are adapted to the present (one or more same or different) hardware interfaces 42a-c and suitably serve the same with regard to data format and/or timing and/or electric specifications and/or protocol.

When in the superordinated programmable logic control 42 a plurality of interfaces to connect to a plurality of numerical control systems 41a-c are provided, these interfaces can have specifications equal to each other, but also two or more different specifications which are, however, suitably served.

When a plurality of interfaces 42a-c are provided, instead of a second program 25 for serving the plurality of interfaces, also a plurality of second programs 25 for operating respectively fewer interfaces 42a-c (i.e. not all present interfaces, possibly only one) can be generated which, then, have interfaces to connect to each other.

The second program(s) 25 can respectively be an already mentioned cyclically designed program.

In the structure of FIG. 4 the second program 25 serves indirectly for the process or machine control by acting via interfaces 42a-d using the numerical control systems 9, 41a-c which directly act on the machine or process components.

The second program 25 can also have program parts which perform the change (deletion, modification, installation) of numerical control programs (9a in FIG. 1) and/or their auxiliary data (9b in FIG. 1) in the individual numerical control systems 41a-c, 9 and, accordingly, the conversion device 20 is designed for converting respective instructions in the first program 15 in corresponding instructions (deletion, modification, installation) of numerical control programs and/or their auxiliary data (9b in FIG. 1) in the individual connected numerical control systems 41a-c, 9.

Interfaces generally comprise hardware components which, in more complex equipments, necessitate a suitable and in many respects adapted operation. As far as in the context of programs, in particular the second program 25, “interfaces” are mentioned, in any case the operation of the interface hardware is meant which is represented in suitable program parts for the implementation or control of the operation of the interface hardware.

With the method and the apparatus according to the invention the creation of control programs for machine tools and/or for programmable logic controls is significantly facilitated, since the machine-oriented programming as well as the multiple programming for different hardware can be omitted. Additionally, the quality is improved since misprogramming becomes more improbable, and the synchronicity of different versions of the program (in different machine languages) is improved.

Generally, the disclosure of method features is alternately also to be understood as the disclosure of an apparatus for performing the respective method as well as the disclosure of a data carrier comprising data which, when they are used in a computer for the execution of a program, yield an appropriate apparatus or implement an appropriate method.

1. A method for creating a program for controlling the operation of a computer-controlled machine, comprising:
providing a conversion program for converting a first program in a programming language into an executable second program in a machine language,
generating a first program in the first programming language, and
converting the first program using the conversion program into an executable second program in the machine language.

2. The method according to claim 1, wherein generating the first program comprises:
prior provision of a collection of program parts,
compilation of program parts from the collection to a first program.

3. The method according to claim 2, wherein writing the first program comprises one or more of the following:
setting parameters for controlling options of the program parts,
assigning storage locations to data to be stored,
selecting options for access to storage locations,
the conversion being effected with reference to the set parameters and/or the assignment of the storage location and/or the selected access option.

4. The method according to claim 2, wherein the writing of the first program and, the compilation and the setting of parameters and/or the assignment of the storage locations and/or the selection of the access option is performed using a graphical user interface.

5. The method according to claim 1,
wherein providing a conversion program comprises generating a conversion program which, starting from the first program, can generate the second program in several machine languages, and
the conversion step comprises selecting a machine language into which the first program is to be converted, and converting the first program into the second program in the selected machine language.

6. The method according to claim 5, wherein plurality of machine languages can be selected simultaneously, and the conversion program generates a plurality of second programs according to the selected machine languages.

7. The method according to claim 1, wherein
the executable second program is a control program for controlling auxiliary machine functions of a machine tool,
a third program is generated which is a work program for controlling machine processing functions for a workpiece, the work program having interfaces to connect to the control program, and
when the first program is converted into the second program, the conversion program forms one or more interfaces in the second program in accordance with information in the first program, which interfaces are compatible to one or more interfaces in the third program.

8. The method according to claim 1, wherein a conversion device generates a program which, in operation, is cyclically repeatedly executed.

9. The method according to claim 1, wherein the second program controls one or more of the following machine functions or comprises one or more interfaces to connect to control systems controlling the following machine functions:
control and monitoring of operating materials,
control and monitoring of the machine status,
user interface,
tool management and tool exchange,
chip control,
workpiece monitoring,
tool monitoring,
safety devices,
axis drive,
operation of sensors,
and/or that the third program controls one or more of the following machine functions:
tool drive,
axis drive,
operation of sensors,
collision monitoring,
and/or that an interface between the second and the third program comprises
format specifications as to data inputs and/or outputs, and/or
timing specifications as to data inputs and/or outputs, and/or
storage specifications for the storing and reading of data, and/or
communication control specifications.

10. The method according to claim 7, wherein the third program for a machine tool is generated by an automaton starting from a digital workpiece definition and in accordance with user inputs.

11. The method according to claim 1, wherein during the conversion, commands are generated in the second program, which relate to the sensor querying and/or the data acquisition of sensors and/or the kind of the analog/digital conversion.

12. The method according to claim 1, wherein during the conversion, commands are generated in the second program, which relate to the influencing of actuators or axes of the machine or the kind of the digital/analog conversion.

13. The method according to claim 1, o wherein the second program is generated for a programmable control and comprises one or more interfaces to connect to numerical control systems of plant components.

14. An apparatus for generating an executable second program in a machine language for controlling an operation of a computer-controlled machine, in particular a machine tool, starting from a first program, the apparatus comprising:
an input device for inputting a first program,
a conversion device for converting the first program into a second program, and
an output device for outputting the second program.

15. The apparatus according to claim 14, comprising
a selection device for selecting one of a plurality of machine languages in which the second program is to be generated, and
wherein the conversion device is configured to generate second program in a selected machine language.

16. (canceled)
